(19) United States
(12) Patent Application Publication
(10) Pub. No.: US 2003/0226054 A1
(43) Pub. Date: Dec. 4, 2003

(54) Clock generation circuit and clock generation method

(76) Inventors: Hiroshi Benno, Katano-shi (JP); Takashi Yoneda, Mishima-gun (JP); Shirou Yoshioka, Nishinomiya-shi (JP)

Correspondence Address: Joseph W. Price, SNELL & WILMER L.L.P., Suite 1200, 1920 Main Street, Irvine, CA, 92614-7230, US

(21) Appl. No.: 10/417,513

(22) Filed: Apr. 17, 2003

(30) Foreign Application Priority Data
Apr. 22, 2002 (JP) 2002-119669

(51) Int. Cl. G06F 1/04

(52) U.S. Cl. 713/500

(57) ABSTRACT

To provide a device and method for preventing a computer from malfunctioning due to external noise, while maintaining continuity of computer processing. A clock generation circuit detects a presence or absence of external noise which enters into the computer. The clock generation circuit generates an operation clock signal whose pulse width is (a) a first width when the external noise is not detected and (b) a second width greater than the first width when the external noise is detected. The clock generation circuit supplies the generated operation clock signal to the computer.

This application is based on an application No. 2002-119669 filed in Japan, the contents of which are hereby incorporated by reference.

### BACKGROUND OF THE INVENTION

1. Field of the Invention

The present invention relates to a clock generation circuit for supplying an operation clock signal to a computer, and a clock generation method used by such a clock generation circuit.

2. Related Art

External noise is one of the leading factors affecting the normal operations of computers. External noise is noise that is introduced into a computer through a line, such as a power supply line or a communication line, which is connected to the computer. Examples of such noise include electrical surges caused by lightning strokes or switching operations. When introduced into a computer, external noise can cause the computer to malfunction.

Various techniques have conventionally been proposed to prevent computers from malfunctioning due to external noise. For instance, Unexamined Patent Application Publications Nos. H01-206438 and S59-87557 disclose devices that detect a malfunction in a computer using a watchdog timer or the like and hard-reset the computer.

However, if the computer is hard-reset upon detecting a malfunction caused by external noise, the execution result of a program which was running up until the hard reset is lost and the program has to be restarted from the beginning. This causes discontinuity in computer processing.

### SUMMARY OF THE INVENTION

In view of the problem described above, the present invention has an object of providing a circuit and method that prevent malfunctions of a computer caused by external noise while maintaining continuity in computer processing.

The stated object can be achieved by a clock generation circuit for supplying an operation clock signal to a computer, including: a noise detecting unit operable to detect a presence or absence of external noise which enters into the computer: a generating unit operable to generate the operation clock signal whose pulse width is (a) a first width when the noise detecting unit does not detect the external noise and (b) a second width greater than the first width when the noise detecting unit detects the external noise; and a supplying unit operable to supply the operation clock signal generated by the generating unit to the computer.

According to this construction, in normal times when no external noise is detected, the clock generation circuit generates the operation clock signal whose pulse width is the first width. When external noise is detected, the clock generation circuit generates the operation clock signal whose pulse width is the second width that is greater than the first width.

Thus, when the external noise enters into the computer, the pulse width of the operation clock signal is extended to suspend the operation of the computer. This keeps the computer from malfunctioning. Since this effect is produced simply by extending the pulse width of the operation clock signal, the continuity of the computer processing is maintained.

Here, the operation clock signal may be a signal that transitions between two different logic states, wherein when the noise detecting unit detects the external noise, the generating unit stops the operation clock signal from transitioning for a period of time corresponding to the second width, and restarts the operation clock signal transitioning after the period of time has passed.

According to this construction, when the external noise is detected, the clock generation circuit keeps the operation clock signal from transitioning for the period of time corresponding to the second width. Only after the period of time has passed, the clock generation circuit allows the operation clock signal to transition. In this way, the pulse width of the operation clock signal is extended.

Here, the generating unit may include: a source clock generating unit operable to generate a source clock signal which is a source of the operation clock signal; a holding signal generating unit operable to generate a holding signal which is a signal that transitions between a first logic state and a second logic state, the holding signal (a) being in the first logic state when the noise detecting unit does not detect the external noise, and (b) being in the second logic state for the period of time and then changing into the first logic state when the noise detecting unit detects the external noise; and a controlling unit operable to (1) acquire the source clock signal and the holding signal, (2) generate the operation clock signal by dividing a frequency of the source clock signal when the holding signal is in the first logic state, and (3) keep the operation clock signal from transitioning when the holding signal is in the second logic state.

According to this construction, the clock generation circuit generates the source clock signal and the holding signal, and generates the operation clock signal using them. In detail, if the holding signal is in the first logic state, the clock generation circuit generates the operation clock signal by dividing the frequency of the source clock signal. In this case, the pulse width of the operation clock signal is the first width. If the holding signal is in the second logic state, the clock generation circuit stops the operation clock signal from transitioning. In this case, the pulse width of the operation clock signal is the second width.

Once the period of time corresponding to the second width has passed since the holding signal changed from the first logic state to the second logic state, the holding signal returns to the first logic state. As a result, the pulse width of the operation clock signal returns to the first width.

Here, the controlling unit may include: a logic circuit that has a data input terminal, and outputs a signal input in the data input terminal with a leading edge of the source clock signal, wherein an exclusive-OR of a signal obtained by inverting the signal output from the logic circuit and the holding signal is input in the data input terminal.

According to this construction, the clock generation circuit generates the operation clock signal by dividing the frequency of the source clock signal when the holding signal is in the first logic state, and stops the operation clock signal from transitioning when the holding signal is in the second logic state.

Here, the controlling unit may include: a logic circuit that has a data input terminal, and outputs a signal input in the data input terminal with a leading edge of an OR of the holding signal and the source clock signal, wherein a signal obtained by inverting the signal output from the logic circuit is input in the data input terminal.

According to this construction, the clock generation circuit generates the operation clock signal by dividing the frequency of the source clock signal when the holding signal is in the first logic state, and stops the operation clock signal from transitioning when the holding signal is in the second logic state.

Here, the second width may be set in advance by a designer.

According to this construction, the designer can freely set or change the pulse width of the operation clock signal, so as to prevent the computer from operating under an unstable condition caused by the external noise.

Here, the clock generation circuit may further include: an interrupting unit operable to interrupt the external noise into the computer, when the noise detecting unit detects the external noise.

According to this construction, the clock generation circuit can prevent the external noise from entering into the computer.

Here, the noise detecting unit may include: a voltage difference monitoring unit operable to monitor a difference between a power supply voltage supplied to the computer and a voltage obtained by attenuating the power supply voltage, wherein the noise detecting unit judges that the external noise is present, when the difference exceeds a predetermined level.

According to this construction, the clock generation circuit detects the external noise using the difference between the power supply voltage and the voltage obtained by attenuating the power supply voltage. This difference is negligible if there is no abnormal change in power supply voltage, but increases when an abnormal change occurs in power supply voltage.

Here, the computer may be supplied with power from a power supply, wherein the noise detecting unit detects the presence or absence of the external noise at a position that is closer than the computer to the power supply.

According to this construction, the external noise reaches the noise detecting unit earlier than circuits in the computer. This improves the likelihood that malfunctions will be prevented, when compared with the case where the external noise reaches the noise detecting unit at the same time as or later than the circuits in the computer.

The stated object can also be achieved by a clock generation method for supplying an operation clock signal to a computer, including: a noise detecting step of detecting a presence or absence of external noise which enters into the computer: a generating step of generating the operation clock signal whose pulse width is (a) a first width when the noise detecting step does not detect the external noise and (b) a second width greater than the first width when the noise detecting step detects the external noise; and a supplying step of supplying the operation clock signal generated by the generating step to the computer.

According to this construction, in normal times when no external noise is detected, the clock generation method generates the operation clock signal whose pulse width is the first width. When external noise is detected, the clock generation method generates the operation clock signal whose pulse width is the second width that is greater than the first width.

Thus, when the external noise enters into the computer, the pulse width of the operation clock signal is extended to suspend the operation of the computer. This keeps the computer from malfunctioning. Since this effect is produced simply by extending the pulse width of the operation clock signal, the continuity of the computer processing is maintained.

Here, the operation clock signal may be a signal that transitions between two different logic states, wherein when the noise detecting step detects the external noise, the generating step stops the operation clock signal from transitioning for a period of time corresponding to the second width, and restarts the operation clock signal transitioning after the period of time has passed.

According to this construction, when the external noise is detected, the clock generation method keeps the operation clock signal from transitioning for the period of time corresponding to the second width. Only after the period of time has passed, the clock generation method allows the operation clock signal to transition. In this way, the pulse width of the operation clock signal is extended.

Here, the second width may be set in advance by a designer.

According to this construction, the designer can freely set or change the pulse width of the operation clock signal, so as to prevent the computer from operating under an unstable condition caused by the external noise.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows a construction of a clock generation circuit to which the first and second embodiments of the invention relate;

FIG. 2 shows a specific example of a clock control circuit in the first embodiment;

FIG. 3 is a time chart of an operation of the clock control circuit shown in FIG. 2;

FIG. 4 shows another specific example of the clock control circuit in the first embodiment;

FIG. 5 is a time chart of an operation of the clock control circuit shown in FIG. 4;

FIG. 6 is a flowchart showing an operation of the clock generation circuit in the first embodiment;

FIG. 7 shows a specific example of a noise detection circuit in the first embodiment;

FIG. 8 shows another specific example of the noise detection circuit in the first embodiment;

FIG. 9 shows positioning of the noise detection circuit;

FIG. 10 shows an equivalent circuit of the noise detection circuit;

FIG. 11 is a time chart of an operation of the noise detection circuit;

FIG. 12 shows a specific example of a clock control circuit in the second embodiment;

FIG. 13 is a time chart of an operation of the clock control circuit shown in FIG. 12;

FIG. 14 shows a construction of a clock generation circuit to which the third embodiment of the invention relates;

FIG. 15 is a time chart of an operation of the clock generation circuit shown in FIG. 14; and

FIG. 16 shows a specific example of a power supply switch shown in FIG. 14.

### DESCRIPTION OF THE PREFERRED EMBODIMENTS

First Embodiment

The following describes the first embodiment of the present invention in conjunction with drawings.

(Construction)

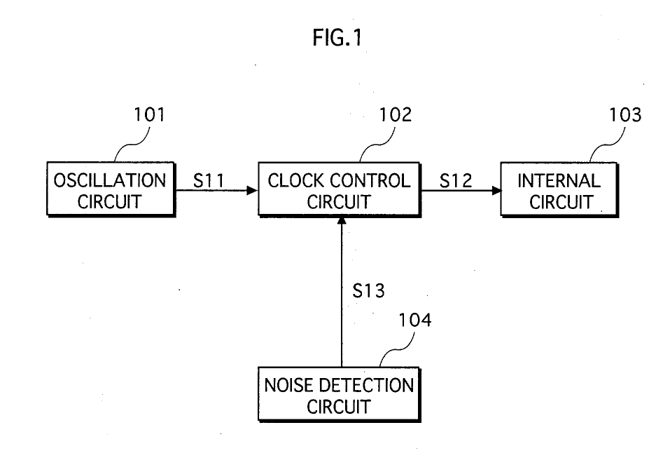

FIG. 1 shows a construction of a clock generation circuit.

This clock generation circuit is roughly made up of an oscillation circuit 101, a clock control circuit 102, and a noise detection circuit 104, and generates an operation clock signal for synchronizing the operations of circuits in an internal circuit 103.

The oscillation circuit 101 generates a periodic source clock signal S11, and outputs it to the clock control circuit 102.

The clock control circuit 102 divides the frequency of the source clock signal S11 to generate an internal clock signal S12, and outputs it to the internal circuit 103. This internal clock signal S12 is the operation clock signal used to synchronize the operations in the internal circuit 103.

The internal circuit 103 includes a storage circuit, an arithmetic circuit, a control circuit, and the like that constitute a computer. The internal circuit 103 operates in sync with the internal clock signal S12.

The noise detection circuit 104 detects external noise which is introduced into the internal circuit 103, and outputs a detection signal S13 to the clock control circuit 102.

If the detection signal S13 is not output from the noise detection circuit 104, the clock control circuit 102 generates the internal clock signal S12 by dividing the frequency of the source clock signal S11 output from the oscillation circuit 101, and outputs it to the internal circuit 103.

If the detection signal S13 is output from the noise detection circuit 104, the clock control circuit 102 extends the pulse width of the internal clock signal S12 to a predetermined width. This is explained in detail below.

(Construction of the Clock Control Circuit 102)

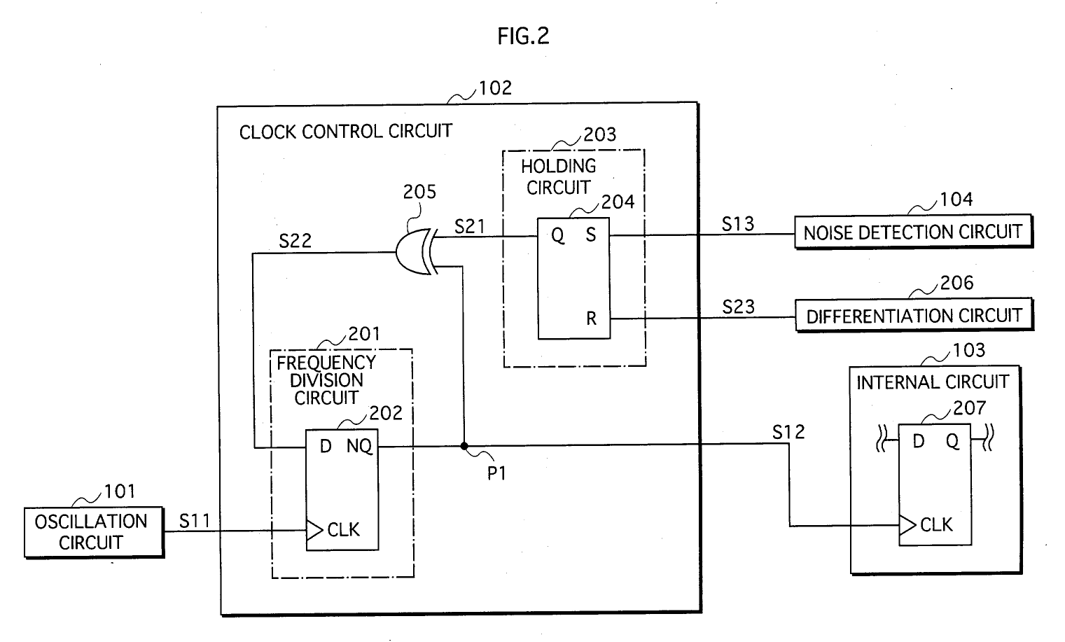

FIG. 2 shows a specific example of the clock control circuit 102 in the first embodiment.

The clock control circuit 102 includes a frequency division circuit 201, a holding circuit 203, and an exclusive-OR element 205.

Also, the clock control circuit 102 is connected with the oscillation circuit 101, the internal circuit 103, the noise detection circuit 104, and a differentiation circuit 206.

The frequency division circuit 201 divides the frequency of the source clock signal S11 to generate the internal clock signal S12. The frequency division circuit 201 includes a D flip-flop 202 (“D” stands for delay).

The D flip-flop 202 has a D input, a CLK input, and an NQ output. The source clock signal S11 is input in the CLK input, and the internal clock signal S12 is output from the NQ output. The internal clock signal S12 is branched at branch point P1, passes the exclusive-OR element 205, and returns to the D input.

The holding circuit 203 outputs an extension signal S21 from when the detection signal S13 is output from the noise detection circuit 104 upon detecting external noise until when a reset signal S23 is output from the differentiation circuit 206. The holding circuit 203 includes an SR latch 204 (“SR” stands for set-reset).

The SR latch 204 has an S input, an R input, and a Q output. The detection signal S13 is input in the S input, the reset signal S23 is input in the R input, and the extension signal S21 is output from the Q output.

The exclusive-OR element 205 receives inputs of the internal clock signal S12 branched at branch point P1 and the extension signal S21 output from the holding circuit 203, and performs an exclusive-OR operation on the two signals to generate an exclusive-OR signal S22.

The differentiation circuit 206 differentiates the source clock signal S11, and outputs the reset signal S23 at regular intervals.

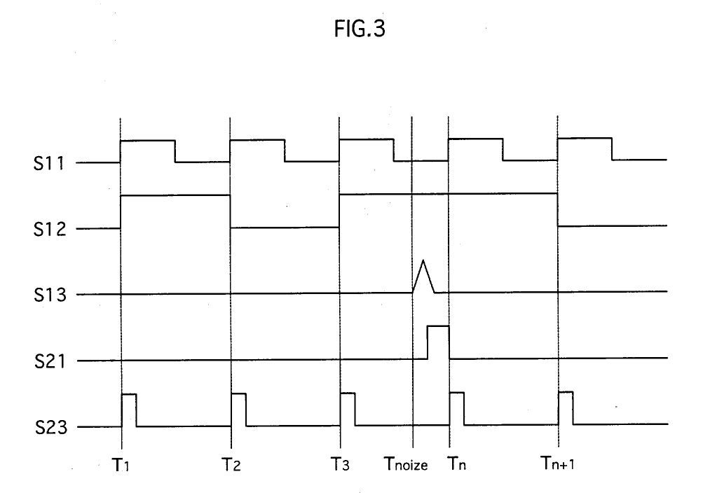

FIG. 3 is a time chart of an operation of the clock control circuit 102 shown in FIG. 2.

From T₁ to T₃, the noise detection circuit 104 does not detect external noise. During this time, the clock control circuit 102 divides the frequency of the source clock signal S11 to generate the internal clock signal S12. The internal clock signal S12 is branched at branch point P1 and enters the exclusive-OR element 205. Since the detection signal S13 is LOW, the extension signal S21 is LOW. Accordingly, the exclusive-OR signal S22 output from the exclusive-OR element 205 is in the same state as the internal clock signal S12. The exclusive-OR signal S22 is then input in the D input of the D flip-flop 202.

At Tₙₒᵢₛₑ, the noise detection circuit 104 detects external noise, and the detection signal S13 becomes HIGH. This being so, the SR latch 204 holds the extension signal S21 HIGH until the next reset signal S23.

As a result, the exclusive-OR signal S22 which is different in state from the internal clock signal S12 branched at branch point P1 is output from the exclusive-OR element 205. Hence the internal clock signal S12 is stopped from transitioning at Tₙ.

At Tₙ, the reset signal S23 is input in the SR latch 204, and the extension signal S21 becomes LOW. As a result, the exclusive-OR signal S22 which is in the same state as the internal clock signal S12 branched at branch point P1 is output from the exclusive-OR element 205. Hence the D flip-flop 202 restarts dividing the frequency of the source clock signal S11 at Tₙ₊₁.

Thus, the clock control circuit 102 extends the pulse width of the internal clock signal S12, according to the detection signal S13 that indicates detection of external noise.

The internal circuit 103 includes a D flip-flop 207. The D flip-flop 207 operates in sync with the leading edges of the internal clock signal S12. Accordingly, when the pulse width of the internal clock signal S12 is extended, the operation of the D flip-flop 207 is suspended responsively.

If external noise enters into the internal circuit 103, the condition of the internal circuit 103 becomes unstable, which may give rise to a malfunction. According to the construction shown in FIG. 2, however, the operation of the internal circuit 103 is suspended for one clock cycle of the source clock signal S11 if external noise enters into the internal circuit 103. This keeps the internal circuit 103 from malfunctioning.

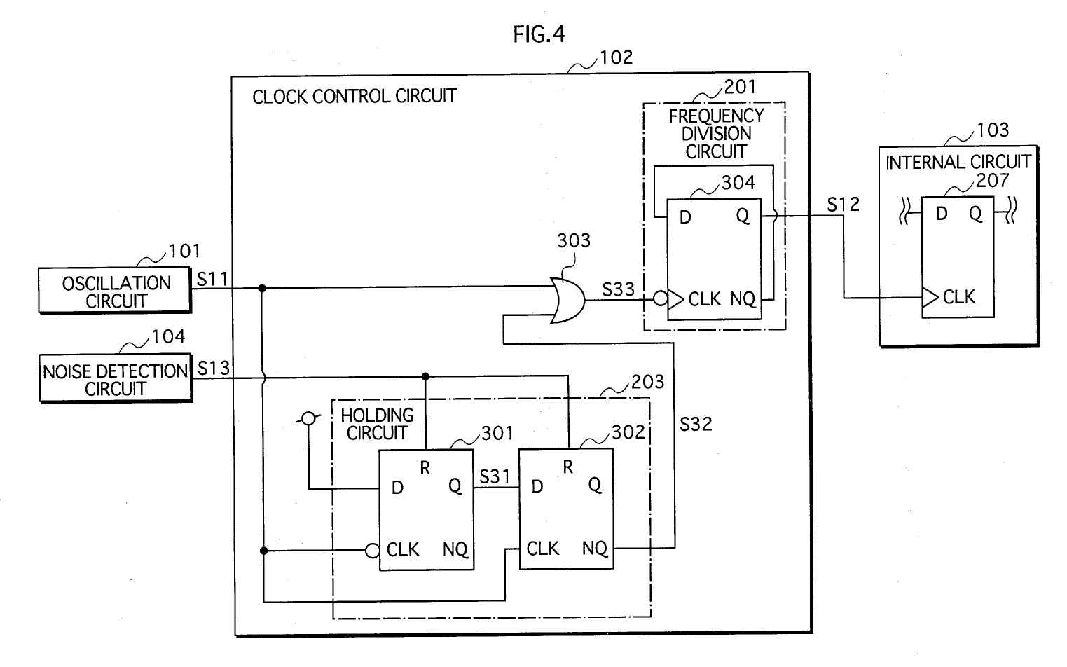

FIG. 4 shows another specific example of the clock control circuit 102 in the first embodiment.

The construction shown in FIG. 4 differs from the construction shown in FIG. 2 in that the holding circuit 203 includes two D latches 301 and 302 instead of the SR latch 204.

The D latch 301 has a D input, a CLK input, an R input, a Q output, and an NQ output. A HIGH is input in the D input. An inverted signal of the source clock signal S11 is input in the CLK input. The detection signal S13 is input in the R input. A signal S31 is output from the Q output.

The D latch 302 has a D input, a CLK input, an R input, a Q output, and an NQ output. The signal S31 is input in the D input. The source clock signal S11 is input in the CLK input. The detection signal S13 is input in the R input. An inverted signal S32 of the Q output is output from the NQ output.

The OR element 303 receives inputs of the source clock signal S11 and the signal S32, and performs an OR operation on the two signals to generate an OR signal S33. The OR signal S33 is input in a CLK input of the frequency division circuit 201.

The frequency division circuit 201 divides the frequency of the OR signal S33 to generate the internal clock signal S12.

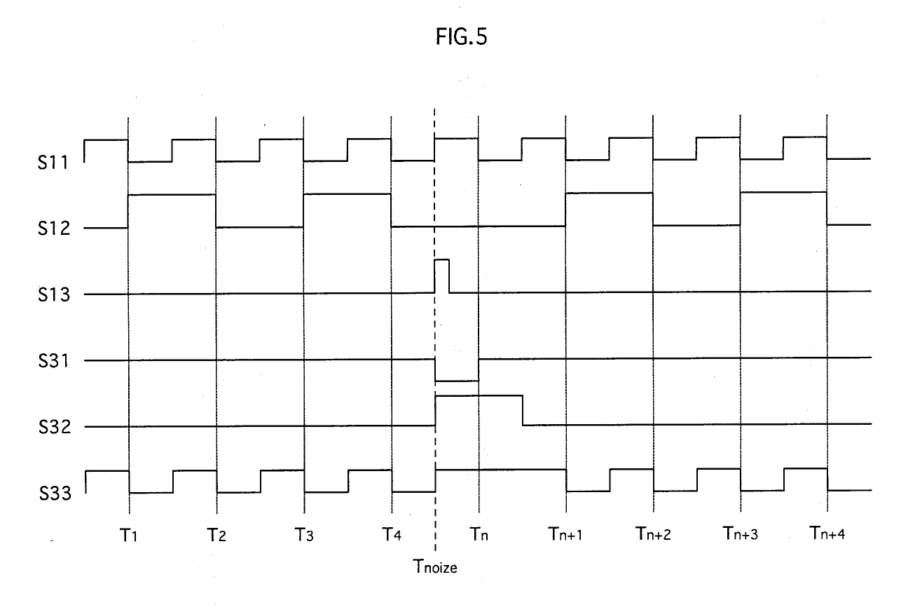

FIG. 5 is a time chart of an operation of the clock control circuit 102 shown in FIG. 4.

From T₁ to T₄, the noise detection circuit 104 does not detect external noise. During this time, the signal S31 output from the Q output of the D latch 301 is HIGH, and the signal S32 output from the NQ output of the D latch 302 is LOW. Accordingly, the source clock signal S11 remains unchanged when passing the OR element 303. In other words, the OR signal S33 output from the OR element 303 is in phase with the source clock signal S11.

At Tₙₒᵢₛₑ, the noise detection circuit 104 detects external noise, and as a result the D latches 301 and 302 are reset. Accordingly, the signal S32 output from the NQ output of the D latch 302 becomes HIGH for one clock cycle of the source clock signal S11. When the signal S32 is HIGH, the OR signal S33 output from the OR element 303 is HIGH, regardless of the state of the source clock signal S11. Which is to say, the OR signal S33 is stopped from transitioning. Accordingly, the pulse width of the internal clock signal S12 output from the frequency division circuit 201 is extended up until Tₙ₊₁.

Thus, the clock control circuit 102 extends the pulse width of the internal clock signal S12 according to the detection signal S13 which indicates detection of external noise, as in the case of FIG. 3. Hence the operation of the D flip-flop 207 in the internal circuit 103 is suspended.

(Operation of the Clock Generation Circuit)

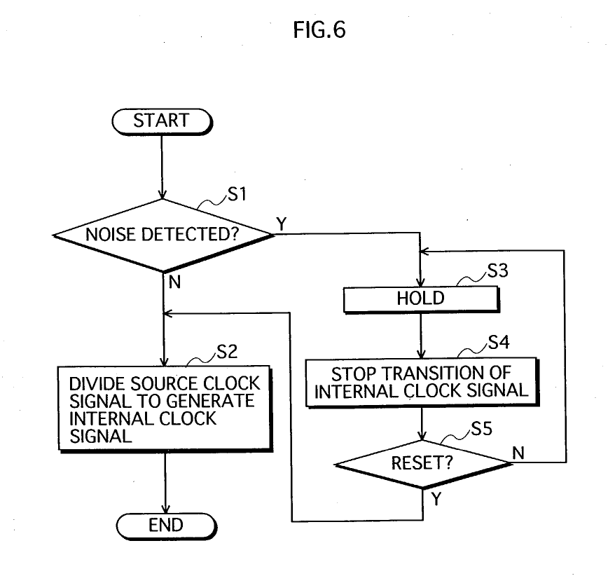

FIG. 6 is a flowchart showing an operation of the clock generation circuit which includes the clock control circuit 102 shown in FIG. 2.

The noise detection circuit 104 monitors whether external noise enters into the internal circuit 103 (S1).

If the noise detection circuit 104 does not detect external noise (S1:NO), the clock control circuit 102 divides the frequency of the source clock signal S11 to generate the internal clock signal S12 (S2).

If the noise detection circuit 104 detects external noise (S1:YES), the holding circuit 203 holds the extension signal S21 HIGH (S3).

The exclusive-OR element 205 exclusive-ORs the internal clock signal S12 and the extension signal S21 to generate the exclusive-OR signal S22 which is in the same state as the internal clock signal S12. In other words, the internal clock signal S12 is stopped from transitioning (S4).

After this, if the holding circuit 203 receives the reset signal S23 (S5:YES), the extension signal S21 becomes LOW. As a result, the internal clock signal S12 resumes transitioning. The clock control circuit 102 divides the frequency of the source clock signal S11 to generate the internal clock signal S12 (S2).

If the holding circuit 203 does not receive the reset signal S23 (S5:NO),the extension signal S21 remains HIGH (S3).

In this way, the clock control circuit 102 can extend the pulse width of the internal clock signal S12 upon detection of external noise, through the use of an SR latch.

(Construction of the Noise Detection Circuit 104)

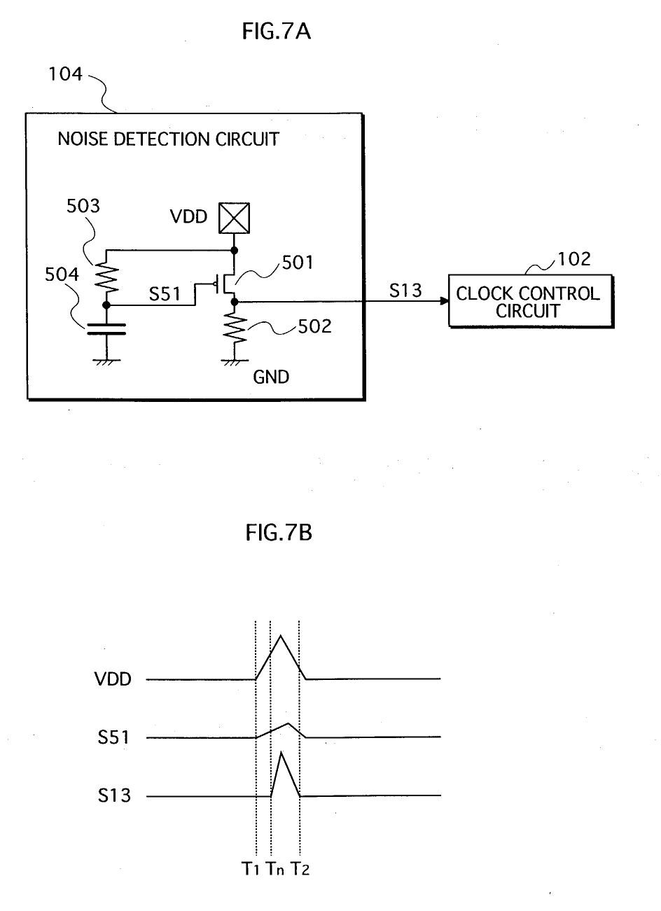

FIG. 7 shows a specific example of the noise detection circuit 104.

FIG. 7A illustrates a circuit that can detect an abnormal increase in a power supply VDD.

A p-channel transistor 501 has a source connected to the power supply VDD, a drain connected to a ground GND via a resistor 502, and a gate connected to the power supply VDD via an integration circuit of a resistor 503 and a capacitor 504. The drain of the p-channel transistor 501 is also connected to the clock control circuit 102. The potential of this drain is the detection signal S13.

FIG. 7B is a time chart of an operation of this noise detection circuit 104.

Before T₁, the power supply VDD does not have an abnormal potential caused by external noise. This being so, the gate potential S51 of the p-channel transistor 501 is at the VDD level. In this condition, the p-channel transistor 501 is OFF, and the detection signal S13 is at the GND level.

At T₁, a potential anomaly occurs in the power supply VDD due to external noise. As a result, the source potential of the p-channel transistor 501 increases with the increase in the VDD level. Meanwhile, the increase of the gate potential S51 is delayed by the integration circuit. This causes a potential difference between the source and gate of the p-channel transistor 501. At Tₙ, the potential difference exceeds a predetermined value. As a result, the p-channel transistor 501 becomes ON. Hence the drain potential, i.e. the detection signal S13, becomes the VDD level. Note here that the predetermined value is set in accordance with the characteristics of the components of the circuit such as the resistors, the capacitor, and the transistor.

At T₂, the potential difference between the VDD level and the gate potential S51 becomes zero. Accordingly, the p-channel transistor 501 returns to OFF, and the detection signal S13 becomes the GND level.

According to this construction, it is possible to detect an abnormal increase in potential of the power supply VDD caused by external noise.

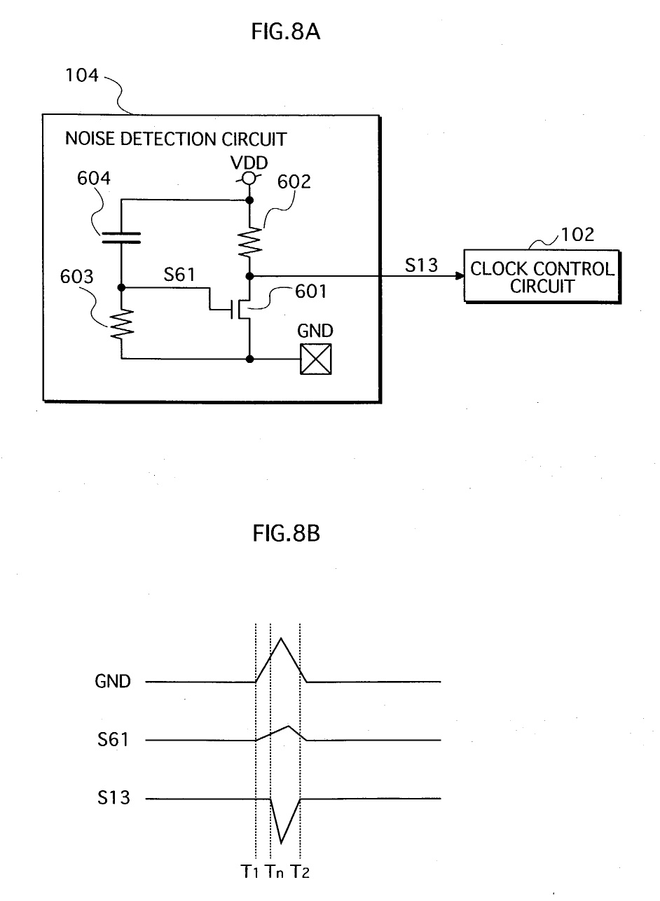

FIG. 8 shows another specific example of the noise detection circuit 104.

FIG. 8A illustrates a circuit that can detect an abnormal increase in the ground GND.

An n-channel transistor 601 has a source connected to the ground GND, a drain connected to the power supply VDD via a resistor 602, and a gate connected to the ground GND via an integration circuit of a resistor 603 and a capacitor 604. The drain of the n-channel transistor 601 is also connected to the clock control circuit 102. The potential of this drain is the detection signal S13.

FIG. 8B is a time chart of an operation of this noise detection circuit 104.

Before T₁, the ground GND does not have an abnormal potential caused by external noise. This being so, the gate potential S61 of the n-channel transistor 601 is at the GND level. In this condition, the n-channel transistor 601 is OFF, and the detection signal S13 is at the VDD level.

At T₁, a potential anomaly occurs in the ground GND due to external noise. As a result, the source potential of the n-channel transistor 601 increases with the increase in the GND level. Meanwhile, the increase of the gate potential S61 is delayed by the integration circuit. This causes a potential difference between the source and gate of the n-channel transistor 601. At Tₙ, the potential difference exceeds a predetermined value. As a result, the n-channel transistor 601 becomes ON. Hence the drain potential, i.e. the detection signal S13, becomes the GND level. Note here that the predetermined value is set in accordance with the characteristics of the components of the circuit such as the resistors, the capacitor, and the transistor.

At T₂, the potential difference between the GND level and the gate potential S61 becomes zero. Accordingly, the n-channel transistor 601 returns to OFF, and the detection signal S13 becomes the VDD level.

According to this construction, it is possible to detect an abnormal increase in potential of the ground GND caused by external noise.

Though FIGS. 7 and 8 describe examples of detecting an abnormal potential increase in VDD or GND, an abnormal potential decrease in VDD or GND may equally be detected. Since circuits for detecting such abnormal potential decreases in VDD or GND are well known, their explanation has been omitted here.

(Positioning of the Noise Detection Circuit 104)

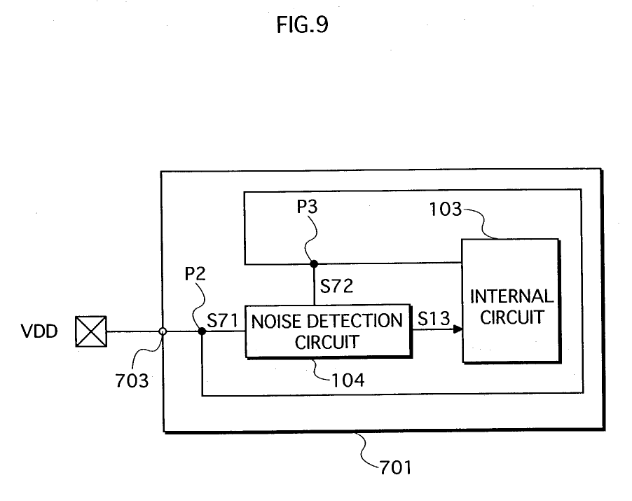

FIG. 9 shows an example position of the noise detection circuit 104.

A power supply VDD supplies power to the circuits on a substrate 701 through a power supply terminal 703. A signal output from the power supply VDD branches at branch point P2. One signal becomes an input signal S71 of the noise detection circuit 104. The other signal travels a long path to branch point P3, where it further branches into power S72 for the noise detection circuit 104 and power for the internal circuit 103.

Thus, the length of the travel of the input signal S71 from the power supply terminal 703 is set shorter than that of the power S72 from the power supply terminal 703. Also, the noise detection circuit 104 obtains the input signal S71 at a position that is closer than the internal circuit 103 to the power supply terminal 703.

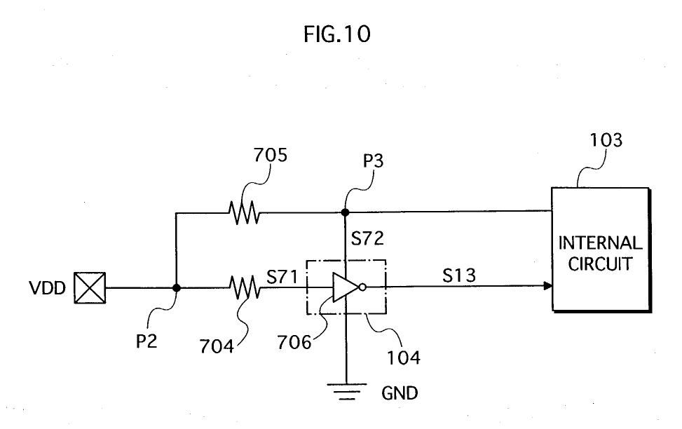

FIG. 10 shows an equivalent circuit of this noise detection circuit 104.

In the drawing, an inversion element 706 is employed as the noise detection circuit 104. The inversion element 706 receives the input signal S71 passing through a parasitic resistor 704. The inversion element 706 also receives the power S72 passing through a parasitic resistor 705. As explained earlier, the power S72 travels longer than the input signal S71, so that the parasitic resistor 705 has greater resistance than the parasitic resistor 704.

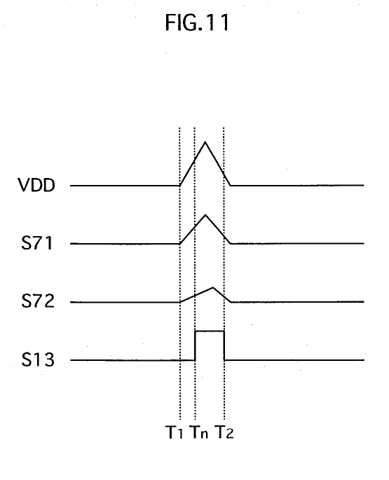

An operation of the noise detection circuit 104 with the above construction is explained below, with reference to FIG. 11.

FIG. 11 is a time chart of an operation of the noise detection circuit 104.

Before T₁, the power supply VDD does not have an abnormal potential caused by external noise. In this condition, the input signal S71 and the power S72 of the inversion element 706 are both at the VDD level. Accordingly, the detection signal S13 output from the inversion element 706 is at the GND level.

At T₁, a potential anomaly occurs in the power supply VDD due to external noise. Since the power S72 passes through greater parasitic resistance than the input signal S71, the potential of the power S72 varies less than the potential of the input signal S71. At Tₙ, a potential difference between the input signal S71 and the power S72 exceeds a predetermined value. As a result, the detection signal S13 output from the inversion element 706 becomes the VDD level.

At T₂, the potential difference between the input signal S71 and the power S72 decreases to zero. As a result, the detection signal S13 output from the inversion element 706 returns to the GND level.

This construction makes it possible to detect potential anomalies in the power supply VDD.

With the provision of the above clock control circuit 102 and noise detection circuit 104, the clock generation circuit can prevent the internal circuit 103 from malfunctioning when external noise occurs, by extending the pulse width of the internal clock signal S12.

Second Embodiment

The following describes the second embodiment of the present invention with conjunction with drawings.

(Construction)

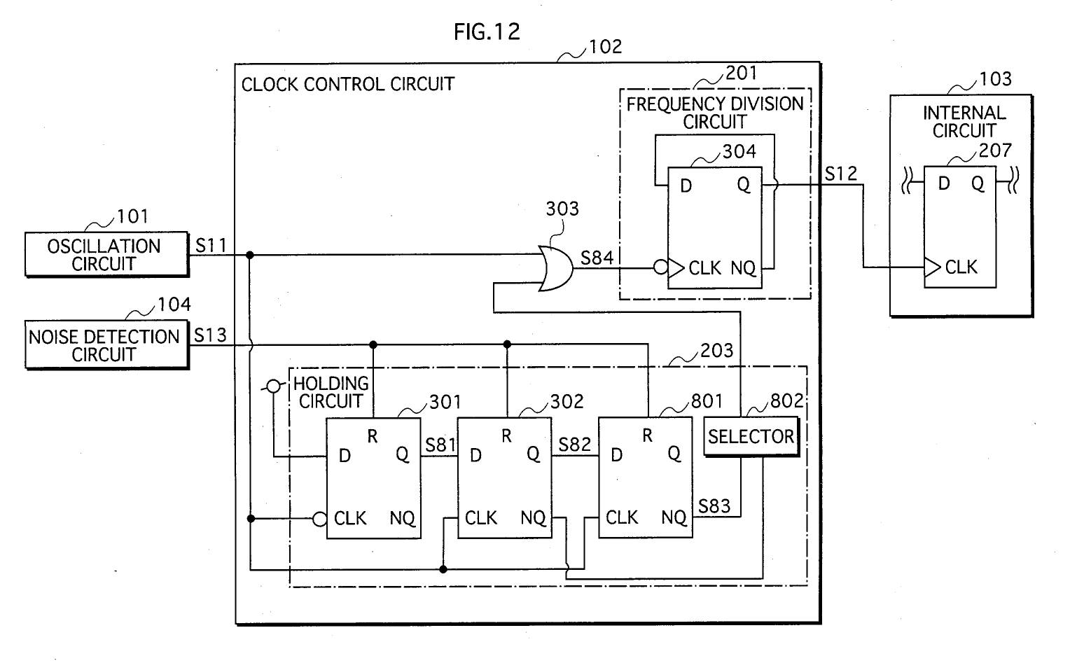

FIG. 12 shows a specific example of the clock control circuit 102 to which the second embodiment relates.

The construction shown in FIG. 12 differs from the construction shown in FIG. 4 only in that a D latch 801 and a selector 802 are newly included in the holding circuit 203. Accordingly, construction elements which are the same as those in FIG. 4 are given the same reference numerals and their explanation has been omitted here.

The D latch 801 has a D input, a CLK input, an R input, a Q output, and an NQ output. A signal S82 output from the Q output of the D latch 302 is input in the D input. The source clock signal S11 is input in the CLK input. The detection signal S13 is input in the R input. An inverted signal S83 of the Q output is output from the NQ output.

The selector 802 receives an inverted signal of the signal S82 from the D latch 302 and the inverted signal S83 from the D latch 801, and outputs one of them to the OR element 303. Here, a designer can set which of the signals is to be output from the selector 802. In the present example, it is assumed that the selector 802 outputs the inverted signal S83 of the D latch 801.

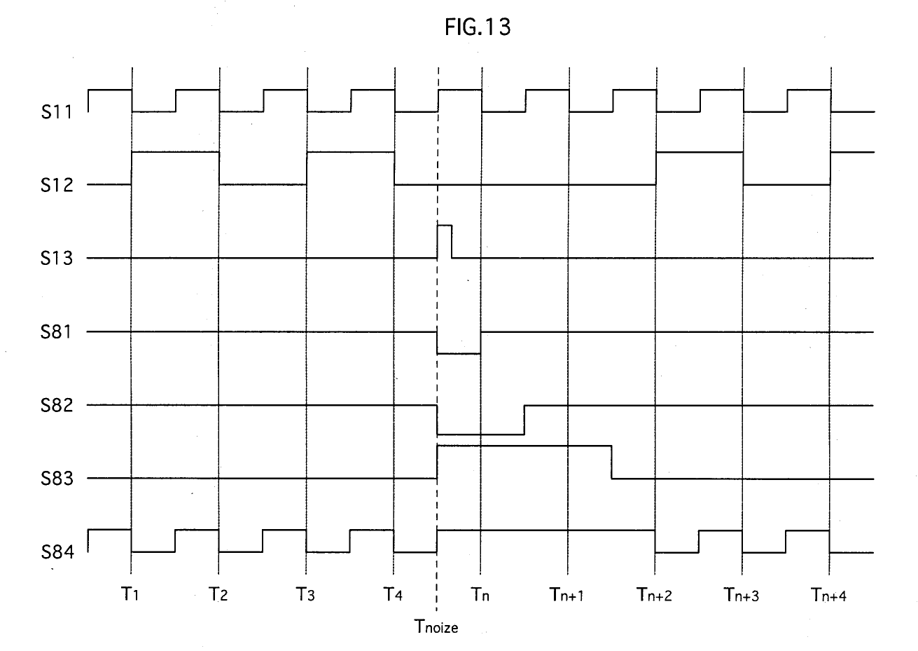

FIG. 13 is a time chart of an operation of the clock control circuit 102 shown in FIG. 12.

From T₁ to T₄, the noise detection circuit 104 does not detect external noise. During this time, the signal S82 output from the Q output of the D latch 302 is HIGH, and the signal S83 output from the NQ output of the D latch 801 is LOW.

At Tₙₒᵢₛₑ, the noise detection circuit 104 detects external noise, so that the D latches 301, 302, and 801 are reset. As a result, the signal S83 output from the NQ output of the D latch 801 becomes HIGH for two clock cycles of the source clock signal S11. Hence the pulse width of the internal clock signal S12 is extended up until Tₙ₊₂. In the first embodiment, the pulse width of the internal clock signal S12 is extended up until Tₙ₊₁ when external noise is detected. In the second embodiment, on the other hand, the pulse width can be extended up until Tₙ₊₂, with the provision of an additional D latch in the holding circuit 203.

It should be obvious that the pulse width of the internal clock signal S12 can freely be varied by adding a plurality of D latches in the same manner.

Third Embodiment

The following describes the third embodiment of the present invention in conjunction with drawings.

(Construction)

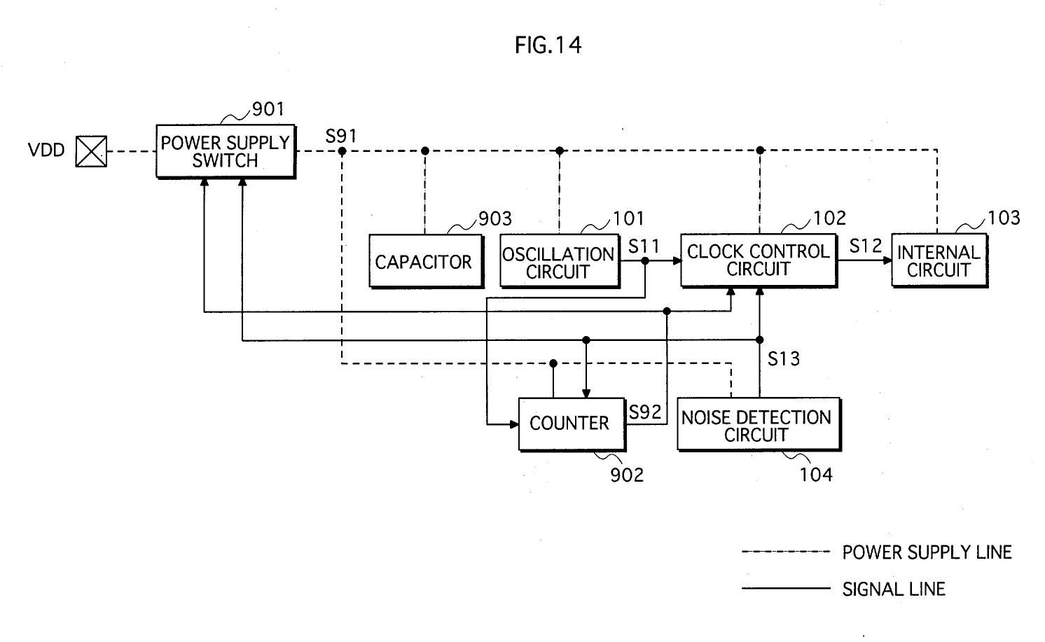

FIG. 14 shows a construction of a clock generation circuit to which the third embodiment relates.

The construction shown in FIG. 14 differs from the construction shown in FIG. 1 only in that a power supply switch 901, a counter 902, and a capacitor 903 are newly included. Accordingly, construction elements which are the same as those in FIG. 1 are given the same reference numerals and their explanation has been omitted here.

The power supply switch 901 connects/disconnects a power supply VDD from each of the circuits such as the oscillation circuit 101, the clock control circuit 102, the internal circuit 103, the noise detection circuit 104, the counter 902, and the capacitor 903. The power supply VDD supplies power to each circuit via the power supply switch 901. The power supply switch 901 receives inputs of the detection signal S13 and a counter output signal S92. When the detection signal S13 is input, the power supply switch 901 disconnects the power supply VDD from each circuit. When the counter output signal S92 is input, the power supply switch 901 connects the power supply VDD to each circuit.

The counter 902 receives inputs of the source clock signal S11 and the detection signal S13. When the detection signal S13 is input, the counter 902 starts counting the source clock signal S11. When the count reaches a predetermined number, the counter 902 outputs the counter output signal S92 to the power supply switch 901 and the clock control circuit 102.

The capacitor 903 stores an electrical charge. When the power supply switch 901 disconnects the power supply VDD from each circuit, the capacitor 903 supplies power to each circuit.

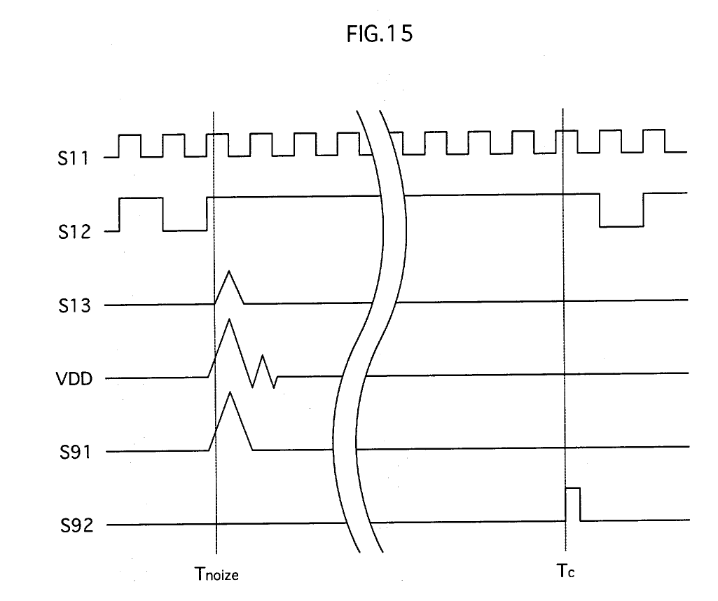

FIG. 15 is a time chart of an operation of this clock generation circuit.

At Tₙₒᵢₛₑ, potential abnormality occurs in the power supply VDD due to external noise. As a result, power S91 which is supplied to each circuit becomes abnormal too. The noise detection circuit 104 detects this potential abnormality, and outputs the detection signal S13 to the clock control circuit 102, the power supply switch 901, and the counter 902.

Upon receipt of the detection signal S13, the clock control circuit 102 stops the internal clock signal S12 from transitioning. Here, the clock control circuit 102 uses an SR latch as shown in the first embodiment.

Upon receipt of the detection signal S13, the power supply switch 901 disconnects the power supply VDD from each circuit. Though the power supply VDD is cut off as a result of this, the power S91 remains at a fixed potential because the capacitor 903 supplies power.

Upon receipt of the detection signal S13, the counter 902 starts counting the source clock signal S11. At T_{c}, the count reaches the predetermined number. Accordingly, the counter 902 outputs the counter output signal S92 to the clock control circuit 102 and the power supply switch 901.

The clock control circuit 102 uses the counter output signal S92 as a reset signal. This being so, upon receipt of the counter output signal S92, the clock control circuit 102 restarts the internal clock signal S12 transitioning.

Upon receipt of the counter output signal S92, the power supply switch 901 connects the power supply VDD to each circuit.

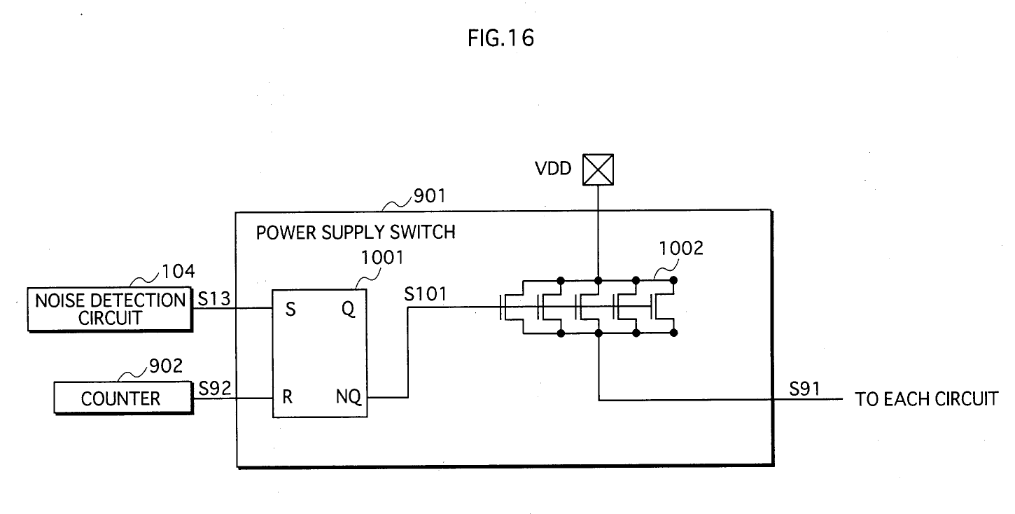

FIG. 16 shows a specific example of the power supply switch 901 shown in FIG. 14.

In the drawing, the power supply switch 901 includes an SR latch 1001 and an n-channel transistor group 1002.

The SR latch 1001 has an S input, an R input, a Q output, and an NQ output. The detection signal S13 output from the noise detection circuit 104 is input in the S input. The counter output signal S92 output from the counter 902 is input in the R input. A power supply control signal S101 which is an inverted signal of the Q output is output from the NQ output.

The n-channel transistor group 1002 has a source connected to the power supply VDD and a drain connected to each circuit. The power supply control signal S101 output from the SR latch 1001 is input in a gate of the n-channel transistor group 1002.

According to this construction, when the power supply VDD does not have an abnormal potential caused by external noise, the power supply control signal S101 is HIGH and the n-channel transistor group 1002 is ON. When the noise detection circuit 104 detects external noise, on the other hand, the power supply control signal S101 becomes LOW and the n-channel transistor group 1002 becomes OFF. The n-channel transistor group 1002 remains OFF, until the counter output signal S92 is output from the counter 902.

Thus, the power supply switch 901 disconnects the power supply VDD from each circuit, from when the detection signal S13 is input until when the counter output signal S92 is input. Also, the extent to which the pulse width of the internal clock signal S12 should be extended can be freely changed according to settings in the counter 902.

By disconnecting the power supply VDD from each circuit, the clock generation circuit can keep external noise which causes potential abnormality of the power supply VDD from entering into each circuit. This is particularly effective when external noise that exceeds the breakdown voltage of each circuit occurs. Furthermore, by extending the pulse width of the internal clock signal S12 according to the detection signal S13 which indicates detection of external noise as in the first and second embodiments, the clock generation circuit can suspend the operation of the D flip-flop 207 in the internal circuit 103.

The above first to third embodiments describe the case where the invention is used for a circuit having a single source clock, though the invention may equally be used for a circuit having a plurality of source clocks.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A clock generation circuit for supplying an operation clock signal to a computer, comprising:
a noise detecting unit operable to detect a presence or absence of external noise which enters into the computer:
a generating unit operable to generate the operation clock signal whose pulse width is (a) a first width when the noise detecting unit does not detect the external noise and (b) a second width greater than the first width when the noise detecting unit detects the external noise; and
a supplying unit operable to supply the operation clock signal generated by the generating unit to the computer.

2. The clock generation circuit of claim 1,
wherein the operation clock signal is a signal that transitions between two different logic states, and
when the noise detecting unit detects the external noise, the generating unit stops the operation clock signal from transitioning for a period of time corresponding to the second width, and restarts the operation clock signal transitioning after the period of time has passed.

3. The clock generation circuit of claim 2,
wherein the generating unit includes:
a source clock generating unit operable to generate a source clock signal which is a source of the operation clock signal;
a holding signal generating unit operable to generate a holding signal which is a signal that transitions between a first logic state and a second logic state, the holding signal (a) being in the first logic state when the noise detecting unit does not detect the external noise, and (b) being in the second logic state for the period of time and then changing into the first logic state when the noise detecting unit detects the external noise; and
a controlling unit operable to (1) acquire the source clock signal and the holding signal, (2) generate the operation clock signal by dividing a frequency of the source clock signal when the holding signal is in the first logic state, and (3) keep the operation clock signal from transitioning when the holding signal is in the second logic state.

4. The clock generation circuit of claim 3,
wherein the controlling unit includes:
a logic circuit that has a data input terminal, and outputs a signal input in the data input terminal with a leading edge of the source clock signal, and
an exclusive-OR of a signal obtained by inverting the signal output from the logic circuit and the holding signal is input in the data input terminal.

5. The clock generation circuit of claim 3,
wherein the controlling unit includes:
a logic circuit that has a data input terminal, and outputs a signal input in the data input terminal with a leading edge of an OR of the holding signal and the source clock signal, and
a signal obtained by inverting the signal output from the logic circuit is input in the data input terminal.

6. The clock generation circuit of claim 1,
wherein the second width is set in advance by a designer.

7. The clock generation circuit of claim 1 further comprising:
an interrupting unit operable to interrupt the external noise into the computer, when the noise detecting unit detects the external noise.

8. The clock generation circuit of claim 1,
wherein the noise detecting unit includes:
a voltage difference monitoring unit operable to monitor a difference between a power supply voltage supplied to the computer and a voltage obtained by attenuating the power supply voltage, and
the noise detecting unit judges that the external noise is present, when the difference exceeds a predetermined level.

9. The clock generation circuit of claim 1,
wherein the computer is supplied with power from a power supply, and
the noise detecting unit detects the presence or absence of the external noise at a position that is closer than the computer to the power supply.

10. A clock generation method for supplying an operation clock signal to a computer, comprising:
a noise detecting step of detecting a presence or absence of external noise which enters into the computer:
a generating step of generating the operation clock signal whose pulse width is (a) a first width when the noise detecting step does not detect the external noise and (b) a second width greater than the first width when the noise detecting step detects the external noise; and
a supplying step of supplying the operation clock signal generated by the generating step to the computer.

11. The clock generation method of claim 10,
wherein the operation clock signal is a signal that transitions between two different logic states, and
when the noise detecting step detects the external noise, the generating step stops the operation clock signal from transitioning for a period of time corresponding to the second width, and restarts the operation clock signal transitioning after the period of time has passed.

12. The clock generation method of claim 10,
wherein the second width is set in advance by a designer.
